(19) United States
(12) Patent Application Publication
(10) Pub. No.: US 2024/0253127 A1
(43) Pub. Date: Aug. 1, 2024

(54) TOOL FOR MACHINING

(71) Applicant: Hartmetall-Werkzeugfabrik Paul Horn GmbH, Tuebingen (DE)

(72) Inventor: Markus KANNWISCHER, Ergenzingen (DE)

(21) Appl. No.: 18/630,128

(22) Filed: Apr. 9, 2024

Related U.S. Application Data
(63) Continuation of application No. PCT/EP2022/075031, filed on Sep. 8, 2022.

(30) Foreign Application Priority Data
Oct. 14, 2021 (DE) 10 2021 126 712.9

(51) Int. Cl. B23B 27/10; B23B 27/16

(52) U.S. Cl. CPC B23B 27/10; B23B 27/1614

(57) ABSTRACT

A tool for machining a workpiece. The tool comprises a tool holder with an internal coolant channel and a cutting insert detachably fixed to the tool holder. A gap is provided between the top side and a superstructure of the tool holder arranged above the cutting plate, on which a coolant outlet opening of the coolant channel is arranged. To improve the chip flow out of the gap, the height of the gap is getting larger towards the front side.

### CROSS-REFERENCE TO RELATED APPLICATIONS

This application is a continuation of international patent application PCT/EP2022/075031, filed on Sep. 8, 2022 designating the U.S., which international patent application has been published in German language and claims priority from German patent application DE 10 2021 126 712.9, filed on Oct. 14, 2021. The entire contents of these priority applications are incorporated herein by reference.

### BACKGROUND

This disclosure relates to a tool for machining a workpiece. This tool may be configured as a turning tool.

The herein presented tool comprises a tool holder and a cutting insert detachably arranged thereon by means of a clamping element. The cutting insert may be configured as an indexable cutting insert.

An internal coolant channel is provided inside the tool holder, by means of which coolant and lubricant (hereinafter referred to simply as “coolant”) can be transported to the region of the machining point, in other words to the region of the cutting edge of the cutting insert used for machining.

An exemplary generic tool that is already known from the prior art is a tool marketed by the applicant under the type designation “Clamping Holder 356” and “Indexable Cutting Insert 315.” The front part of a tool of this kind is shown in detail in FIG. 8.

The tool shown in FIG. 8 is a turning tool which is particularly suitable for grooving. The cutting insert in this case is laterally inserted into a cutting insert receptacle provided in the tool holder and secured in said cutting insert receptacle by means of a clamping screw. This clamping screw presses the cutting insert into the base of the cutting insert receptacle, on the one hand, with a flat surface provided on its rear side. On the other hand, the clamping screw presses the cutting insert peripherally with two bearing surfaces running obliquely to one another against corresponding counter-bearing surfaces of the cutting insert receptacle. On the upper side of the cutting insert opposite these bearing surfaces, the cutting insert is likewise covered at least partially by the tool holder, but it does not bear against the tool holder on this upper side. A coolant outlet opening is arranged in this upper region of the tool holder, which outlet opening is oriented in such a way that the coolant emerging therefrom strikes the upper side of the cutting insert in the region of the active cutting edge. Cooling of the cutting insert therefore takes place very close to the active cutting edge.

In the present case, the term “active” cutting edge is used to refer to the cutting edge of the cutting insert that is used for machining the workpiece in the respective clamp. In the example shown in FIG. 8, the cutting insert has two further cutting edges that can also be used for machining the workpiece, but are arranged in the position shown in FIG. 8 within the cutting insert receptacle and are “inactive” in this position.

Due to the proximity of the coolant outlet to the active cutting edge, the cooling in this tool has certainly proved advantageous.

Due to the fact that the cutting insert does not bear against the tool holder with its upper side, a small gap between the cutting insert and the tool holder is produced between the upper side of the cutting insert and the opposite wall section of the tool holder below the coolant outlet.

It has been observed that chips accumulate to some extent in this small gap and this can cause damage to the cutting insert. This can even mean that the chips are literally pressed into this gap and replacing the cutting insert becomes almost impossible without destroying it.

In order to address this problem, it would initially seem obvious to clamp the cutting insert from its upper side as well, thereby closing this gap. However, with the type of clamping shown in FIG. 8, this would lead to static overdetermination, as the cutting insert would then bear against the tool holder on a total of four sides (three peripheral bearing points and one rear bearing point). Accordingly, one of the two lower bearing points would have to be omitted. However, since the majority of the machining force typically pushes the cutting insert downwards, this would bring with it the risk of the cutting insert being levered out of the cutting insert receptacle due to the load during use, which must be avoided at all costs.

The opposite idea of simply enlarging the gap between the upper side of the cutting insert and the structure of the tool holder opposite this upper side, so that chips are less likely to get stuck in the gap or can be removed from the gap more easily, is not viable either, as the coolant channel or the coolant outlet opening would be in the way in this case, or the entire structure of the tool holder would need to be enlarged which, in turn, is not possible due to space constraints.

As a result, some manufacturers have opted to completely eliminate the structure of the tool holder above the cutting insert and to displace the coolant outlet opening of the internal coolant channel laterally. A configuration of this kind is shown schematically in FIG. 9.

This means that there is no longer a gap between the upper structure of the tool holder and the upper side of the cutting insert, as the space above the upper side of the cutting insert is practically free. Therefore, the problem of chip accumulation mentioned earlier no longer occurs. The nature of the clamping of the cutting insert in the cutting insert receptacle can also remain the same as shown in FIG. 8.

However, a disadvantage of the configuration shown in FIG. 9 is that the coolant now has to be sprayed obliquely towards the active cutting edge, which can be problematic, above all in deep grooves or when working on a shoulder, as the coolant can then scarcely reach the active cutting edge, as it is obscured by the workpiece being machined.

### SUMMARY

It is an object to provide a tool of the kind referred to above that can address the previously mentioned problems. In particular, chips should be prevented from accumulating between the upper side of the cutting insert and the tool holder and being pressed therein in an undesirable manner. The coolant supply should nevertheless be as close to the cutting edge as possible, and a stable method of clamping the cutting insert in the tool holder must definitely be guaranteed.

According to an aspect, a tool is presented, comprising:
a cutting insert having a first side, an opposite second side and a circumferential surface extending between the first side and the second side, wherein a first cutting insert bearing section and a second cutting insert bearing section extending transversely thereto are arranged on the circumferential surface, and a third cutting insert bearing section is arranged on the second side, wherein the cutting insert has an active cutting edge arranged on a upper side forming a part of the circumferential surface and facing away from the first and the second cutting insert bearing section;
a tool holder with a cutting insert receptacle that is configured as an at least relative recess and is configured to receive the cutting insert in such a manner that a first part of the cutting insert is arranged in the recess, and a second part of the cutting insert, on which the active cutting edge is arranged, is located outside the cutting insert receptacle and protrudes at least partially from the tool holder, wherein the cutting insert receptacle is defined by a recess base and a plurality of walls extending transversely thereto, wherein a first holder bearing section is arranged on a first wall of these walls, which first holder bearing section, in the assembled state of the cutting insert, bears against the first cutting insert bearing section, wherein a second holder bearing section is arranged on a second wall of these walls, which second holder bearing section, in the assembled state of the cutting insert, bears against the second cutting insert bearing section, wherein a third holder bearing section is arranged in the recess base, which third holder bearing section, in the assembled state of the cutting insert, bears against the third cutting insert bearing section, and wherein a third wall extending transversely to the first and second wall of the aforementioned walls is opposite the upper side of the cutting insert in the assembled state of the cutting insert, wherein the tool holder further comprises an internal coolant channel that opens into a coolant outlet opening which is oriented towards the upper side of the cutting insert in the assembled state of the cutting insert; and
a clamping element that is configured to be inserted, starting from the first side of the cutting insert, into an opening provided in the cutting insert, penetrating the first and second side, to fasten the cutting insert in a detachable manner to the tool holder and to press the cutting insert with its three cutting insert bearing sections against the corresponding three holder bearing sections of the tool holder; characterized in that the third wall of the cutting insert receptacle, in the assembled state of the cutting insert, is opposite the upper side of the cutting insert, in such a manner that a gap is provided between the third wall of the cutting insert receptacle and the upper side of the cutting insert, the height of which gap increases along a gap depth direction that is parallel to a longitudinal axis of the opening, starting from the second side of the cutting insert towards the first side of the cutting insert, wherein a height of the gap is defined as a distance of the upper side of the cutting insert from the third wall of the cutting insert receptacle.

It should be pointed out that the term “transversely” does not necessarily mean orthogonally or perpendicularly. Instead, it should be understood as referring to any orientation that is not parallel.

Accordingly, the three cutting insert bearing sections and the three corresponding holder bearing sections can be oriented orthogonally to one another. However, this need not be the case; they can also be oriented obliquely to one another at any angle. The first and the second cutting insert bearing section may be oriented obliquely at an angle of less than 90° to one another and orthogonally to the third cutting insert bearing section in each case. The same may apply accordingly to the holder bearing sections.

The cutting insert and holder bearing sections may be point-like or linear or configured as planar sections.

Furthermore, it should be pointed out that the circumferential side of the cutting insert extending between the first side and the second side is referred to as the “circumferential surface” in this context. However, this does not imply a planar surface, but rather a surface composed of many partial surfaces that make up the overall circumference of the cutting insert and can be curved, angled or provided with edges in an arbitrary manner. Instead of the term “circumferential surface,” the term “circumferential side” can also be generally used. Similarly, instead of the terms “first side” and “second side” of the cutting insert, more general terms like “front side” and “rear side” can also be used.

The gap between the upper side of the cutting insert and the opposite third wall of the cutting insert receptacle is configured in such a manner that it widens towards the front, i.e. in the direction from the rear side to the front side of the cutting insert. To be more precise, the height of the gap in the gap depth direction, which runs parallel to the longitudinal axis of the opening, increases starting from the rear side of the cutting insert towards the front side of the cutting insert. The height of the gap is defined as the distance of the upper side of the cutting insert from the third wall of the cutting insert receptacle.

Due to this widening of the gap between the upper side of the cutting insert and the third wall of the cutting insert receptacle, chips can no longer accumulate as easily in the gap, as they are pushed forwards from the gap (so towards the first side of the cutting insert) without being pressed into it. It is also possible to keep the coolant outlet at the same point as is shown in FIG. 8. This also allows for cooling very close to the cutting edge. The method of clamping the cutting insert in the cutting insert receptacle can also remain the same, as previously described in relation to FIG. 8.

A tool is therefore produced with optimal cooling and an extremely stable insert seat, in which the problem of unwanted pressing of the cutting insert in the cutting insert receptacle due an accumulation of chips between the cutting insert and the cutting insert receptacle is solved.

In a refinement, the height of the gap increases continuously along the gap depth direction from the rear side of the cutting insert towards the front side of the cutting insert. There are therefore no sudden changes in the height of the gap along the gap depth direction, and the further one goes along the gap depth direction, viewed from the rear side of the cutting insert, towards the front side of the cutting insert, the greater the height of the gap becomes. However, the increase in the height of the gap along the gap depth direction does not have to be continuous.

It has been found that a continuous increase in the gap height along the gap depth direction is advantageous, in that it helps to prevent lifted chips that enter the gap from becoming trapped in said gap and therefore enables them to leave again quickly, without becoming wedged therein.

In a further refinement, the third wall comprises a first planar surface that extends at an acute angle relative to a second planar surface arranged on the upper side of the cutting insert.

In this configuration, the gap is bounded by two planar surfaces. Consequently, the gap widens in a funnel-like manner towards the front, which is in turn advantageous in relation to chip removal from the gap.

In a further refinement, the acute angle is between 3° and 60°, preferably between 10° and 45°, particularly preferably between 15° and 30°. An angle greater than 15° is particularly preferred, as it prevents self-locking, even if a chip occasionally becomes lodged in the gap.

The particularly preferred upper limit of 30° for the acute angle is based in particular on the fact that, with this kind of orientation of the two planar surfaces on the third wall of the cutting insert receptacle and the upper side of the cutting insert, there is still sufficient space for the internal coolant channel and the coolant outlet opening thereof, allowing for cooling close to the cutting edge from above the cutting insert.

In a further refinement, the second planar surface provided on the upper side of the cutting insert is parallel to a longitudinal axis of the opening through which the clamping element can be introduced. This longitudinal axis of the opening is preferably the symmetry axis of the opening, which coincides with the longitudinal axis of the clamping element.

In a further refinement, the third wall of the cutting insert receptacle completely covers the partial section of the upper side of the cutting insert that belongs to the first part of the cutting insert arranged in the recess.

On the one hand, this simplifies the production of the tool holder, on the other hand, it protects the inactive part of the cutting insert, and still leaves sufficient space for the internal coolant channel and the coolant outlet opening thereof. Consequently, the coolant outlet opening can be oriented centrally with respect to the active cutting edge, despite the increasing height of the gap towards the front.

In a further refinement, the gap is not bounded by two planar surfaces (first and second planar surface). Instead, in this refinement, the third wall is configured as a curved surface. Viewed in cross section, the third wall in this refinement has a concavely curved design. Viewed in cross section, the third wall may be configured as a radius, an ellipsis, or freeform. The aforementioned effect of improved chip removal from the gap also occurs with a shape of this kind.

A third possibility is that the third wall comprises two surfaces oriented transversely to one another that merge into one another along an edge. The two surfaces are therefore angled with respect to one another. In this way, the height of the gap increases even more quickly from this edge towards the front, leading to even better chip removal from the gap, particularly in the front area of the gap.

It should be pointed out that both in the refinement of the third wall as a curved surface and in the last mentioned refinement of the third wall with mutually angled surfaces, the opposite upper side of the cutting insert is still provided with a planar surface (second planar surface) that bounds the gap towards the bottom.

In a further refinement, the first cutting insert bearing section and the second cutting insert bearing section are oriented at an angle 60°. Correspondingly, the first holder bearing section and the second holder bearing section are also oriented at an angle 60° to one another.

For example, in a plan view of the front side, a shape of the cutting insert corresponds substantially to a regular polygon. In the case of a shape resembling an equilateral triangle, the first and the second cutting insert bearing section would be oriented at an angle of 60° to one another. With a shape resembling a square, pentagon, or hexagon, the mentioned angle is 90°, 180°, or 120°, respectively.

In a further refinement, the coolant outlet opening is arranged on a front side component of the tool holder that is integrally formed with the third wall. This front side component is preferably the so-called superstructure that overlaps the cutting insert at least partially.

The integral formation of this superstructure results in a stable tool holder made from as few components as possible.

In a further refinement, an imaginary plane divides the coolant channel into two equal halves, in the assembled state of the cutting insert, intersects the upper side, the first cutting insert bearing section, and the second cutting insert bearing section. It is particularly preferred that this imaginary plane is a plane oriented orthogonally to the longitudinal axis of the clamping element. Furthermore, it is preferred that this imaginary plane is oriented orthogonally to the first and the second cutting insert bearing section and parallel to the third cutting insert bearing section.

In a further refinement, the third cutting insert bearing section is oriented orthogonally to the first and the second cutting insert bearing section. The third cutting insert bearing section may be oriented orthogonally to a longitudinal axis of the opening provided in the cutting insert. The first and the second cutting insert bearing section may be oriented parallel to the longitudinal axis of the opening.

In addition, the cutting insert may be rotationally symmetrical to the longitudinal axis of the opening. “Rotationally symmetrical” is used to describe any body that maps onto itself when rotated about a constant angle of less than 360°.

It is evident that the features referred to above and those yet to be explained below can be used not only in the respective combination indicated, but also in other combinations or individually, without departing from the spirit and scope of the present disclosure.

### BRIEF DESCRIPTION OF THE DRAWINGS

FIG. 1 shows a perspective view of a first exemplary embodiment of the tool;

FIG. 2 shows a plan view from the side of a detail of the tool shown in FIG. 1;

FIG. 3 shows a plan view from the front of the tool shown in FIG. 1;

FIG. 4 shows a schematic longitudinal section IV-IV indicated in FIG. 3;

FIG. 5 shows a schematic cross-section V-V indicated in FIG. 2;

FIGS. 6 and 6b show a perspective view and a cross-sectional view of a second exemplary embodiment of the tool;

FIGS. 7a and 7b show a perspective view and a cross-sectional view of a third exemplary embodiment of the tool;

FIG. 8 shows a perspective view of a detail of a generic tool according to the prior art; and

FIG. 9 shows a perspective view of a detail of another generic tool according to the prior art.

### DESCRIPTION OF PREFERRED EMBODIMENTS

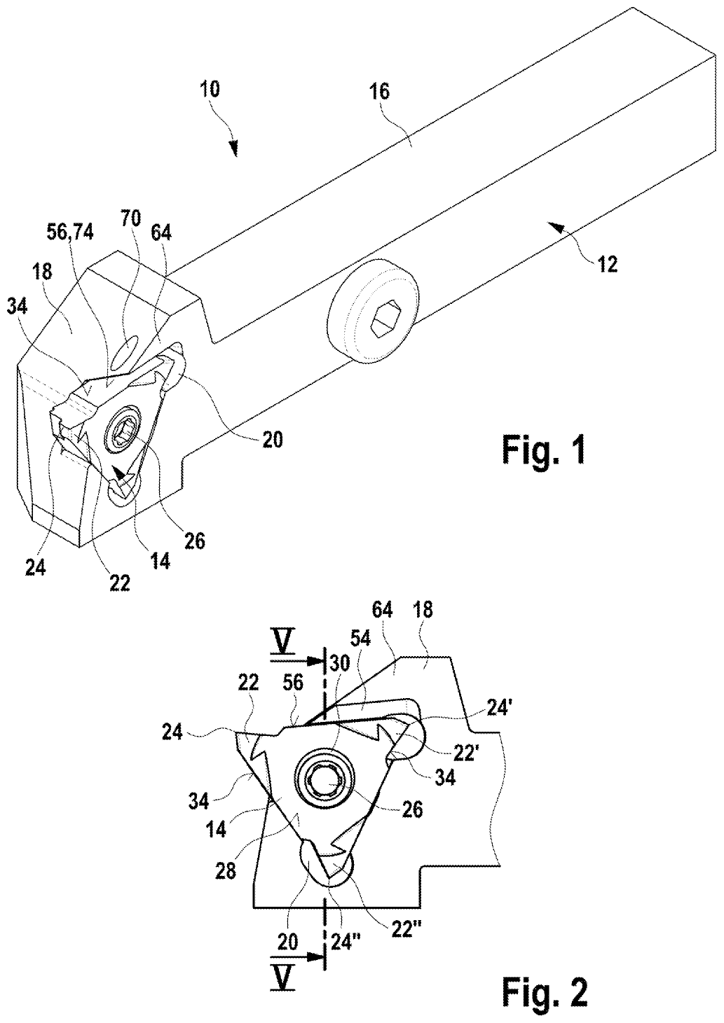

FIGS. 1-7 show three exemplary embodiments of the tool in different views. The tool is generally indicated therein by reference sign 10.

The tool 10 comprises a tool holder 12 and a cutting insert 14 detachably fastened therein. The tool holder 12 has a substantially beam-shaped clamping section 16 and a cutting insert receiving section 18 arranged at the front on the front side thereof. The clamping section 16 is used to clamp the tool holder 12 in a machine tool. The cutting insert receiving section 18 is used to receive the cutting insert 14.

A cutting insert receptacle 20 is laterally provided on the cutting insert receiving section 18 of the tool holder 12, which cutting insert receptacle is used to receive the cutting insert 14. The cutting insert receptacle 20 is configured as a recess and is adapted to receive the cutting insert 14 in such a manner that at least a majority of the cutting insert 14 is arranged in the recess forming the cutting insert receptacle 20, and the remaining part of the cutting insert, which comes into contact with the workpiece when said workpiece is being machined, is located outside of the cutting insert receptacle 20 (see FIG. 2).

In the plan view from the side shown in FIG. 2, the cutting insert 14 is substantially shaped as an equilateral triangle. In each of the three corners of this triangle, the cutting insert 14 has a cutting head 22, 22′,22″ with a cutting edge 24, 24′,24″ for machining a workpiece. The three cutting heads 22, 22′,22″ are preferably configured to be identical to one another, so that they can be used in the same way for machining a workpiece. In the orientation of the cutting insert 14 shown in FIGS. 1 and 2, the cutting head 22 is used for machining the workpiece, while the other two cutting heads 22′,22″ are not used and are accommodated in the cutting insert receptacle 20. The cutting edge 24 of the cutting head 22 is therefore referred to as the “active” cutting edge. Once this active cutting edge 24 is worn, the cutting insert 14 can be detached from the tool holder 12, rotated through 60°, and fastened to the tool holder 12 once again, so that the cutting edge 24′ or 24″ then acts as the active cutting edge.

The cutting insert 14 is fastened to the tool holder 12 by means of a clamping element 26. In the exemplary embodiment shown in the present case, the clamping element 26 is configured as a clamping screw which engages with a corresponding thread 27 provided inside the tool holder 12 (see FIG. 5). However, rather than a clamping screw, a clamping bolt could also be used in principle, which clamping bolt engages with an unthreaded opening in the tool holder 12.

The clamping element 26 is introduced into a central opening 30 in the cutting insert, starting from a first side 28 of the cutting insert 14, as can be seen in FIG. 2. This opening 30 is configured as a through-hole, which passes through both the first side 28 of the cutting insert 14 and also the opposite second side 32 of the cutting insert 14.

Extending between the first side 28 and the second side 32 of the cutting insert 14 is a circumferential surface 34 that runs perpendicularly thereto. This circumferential surface 34 extends about the entire circumference of the cutting insert 14 between the first side 28 and the second side 32. As an equivalent to the terminology “first side” and “second side,” this circumferential surface 34 can also be referred to as the circumferential side of the cutting insert 14.

The clamping element 26 presses the cutting insert 14 in its clamped state into the cutting insert receptacle 20 with both its second side 32 and its circumferential side 34. For this purpose, the cutting insert 14 has three cutting insert bearing sections 36, 38, 40 that abut corresponding holder bearing sections 42, 44, 46 of the cutting insert receptacle 20. The three cutting insert bearing sections 36, 38, 40 run transversely to one another, wherein the first two cutting insert bearing sections 36, 38 are oriented at an angle ≥60° to one another, and the third cutting insert bearing section 40 run orthogonally to the first two cutting insert bearing sections 36, 38. The first two cutting insert bearing sections 36, 38 are arranged on the circumferential side 34 of the cutting insert 14. The third cutting insert bearing section 40 is arranged on the second side 32 of the cutting insert 14.

In the assembled state, the cutting insert 14 abuts the third holder bearing section 46, which is located in the base 48 of the recess forming the cutting insert receptacle 20, with the third cutting insert bearing section 40 arranged on the second side 32. Perpendicular to this recess base 48, the cutting insert receptacle 20 has a plurality of walls 50, 52, 54 that surround the cutting insert 14 circumferentially. The first holder bearing section 42 is arranged on the first wall 50 of these walls, said first holder bearing section abutting the first cutting insert bearing section 36 in the assembled state. The second holder bearing section 44 is arranged on the second wall 52, said second holder bearing section abutting the second cutting insert bearing section 38 in the assembled state. The third wall 54 does not abut the cutting insert 14. In the assembled state of the cutting insert 14, it lies opposite an upper side 86 of the cutting insert 14. A gap 58 is therefore formed between the third wall 54 of the cutting insert receptacle 20 and the upper side 56 of the cutting insert 14 (see FIG. 5). The shape of this gap 58 will be explained in detail below.

The clamping element 26 realized as a clamping screw presses the cutting insert 14 with its three cutting insert bearing sections 36, 38, 40 against the holder bearing sections 42, 44, 46 provided on the walls 50, 52, 54 of the cutting insert receptacle 20. It is easy to understand that the clamping screw 26 presses the third cutting insert bearing section 40 against the third holder bearing section 46 in the assembled state. The pressure of the clamping screw 26 on the first and the second cutting insert bearing section 36, 38 and the first and second holder contact section 42, 44 results from a downward movement of the clamping screw 26. This downward movement is due to the fact that the clamping element longitudinal axis 60, in the assembled state of the cutting insert 14, is slightly offset relative to the longitudinal axis 62 of the opening 30 provided in the cutting insert 14 (see FIGS. 4 and 5). A mechanically defined and stable insert seat is thereby guaranteed.

The upper side 56 of the cutting insert 14 is at least partially covered by a superstructure 64 of the tool holder 12. This superstructure 64 is part of the cutting insert receiving section 18 of the tool holder 12. The superstructure 64 is integrally connected to the clamping section 16 of the tool holder 12. Inside this superstructure 64 is an internal coolant channel 66 (see FIG. 4). The internal coolant channel 66 runs inside the tool holder 12, initially through the clamping section 16, and branches into a transverse bore 68 at the end of the clamping section 16, said transverse bore leading into the superstructure 64. The internal coolant channel 66 finally opens into a coolant outlet opening 70 that is arranged above the cutting insert 14 in the superstructure 64. In the assembled state of the cutting insert 14, the coolant outlet opening 70 is therefore aligned with the upper side 56 thereof. The coolant outlet opening 70 is preferably oriented in such a manner that the coolant exiting from it strikes the active cutting edge 24 arranged on the upper side 56.

The third wall 54 of the cutting insert receptacle 20 forms the lower part of the superstructure 64 that faces the upper side 56 of the cutting insert 14. The previously mentioned gap 58 exists between this third wall 54 and the upper side 56 of the cutting insert 14 (see FIG. 5). This gap 58 widens starting from the second side 32 of the cutting insert 14 towards the first side 28 of the cutting insert 14. To be more precise, the height h of the gap 58 increases along a gap depth direction t starting from the second side 32 towards the first side 28. The height h of the gap 58 refers to the distance of the upper side 56 of the cutting insert 14 from the third wall 54 of the cutting insert receptacle 20. In contrast, the gap depth direction t refers to the dimension of the gap 58, which is measured parallel to the clamping element longitudinal axis 60 or the opening longitudinal axis 62 (see FIG. 5). In the first exemplary embodiment of the tool 10 shown in FIG. 1-5, the third wall 54 has a first planar surface 72 that defines the gap 58 upwardly. On the opposite underside, the gap 58 is bounded by a second planar surface 74, which is arranged on the upper side 56 of the cutting insert 14. The two planar surfaces 72, 74 run at an acute angle α to one another.

A wedge-shaped gap 58 of this kind has the advantage that continuous chips that get into the gap 58 can very easily flow out of the gap 58 again without getting stuck in it. At the same time, the arrangement of the coolant outlet opening 70 is not affected by this, meaning that it can still be directly aligned with the active cutting edge 24, in order to provide cooling as close to the cutting edge as possible.

The size of the angle α is preferably in the range of 3° to 60°. Particularly preferred is a range of 10° to 45°. More particularly preferred is the range of 15° to 30°. Opening angles of this kind have the advantage that self-locking is avoided, even if chips get caught in the gap 58. However, the opening angle α should not become too large, as otherwise the coolant outlet opening 70 would have to be displaced further upwards, which would have an adverse effect on the cooling of the active cutting edge 24.

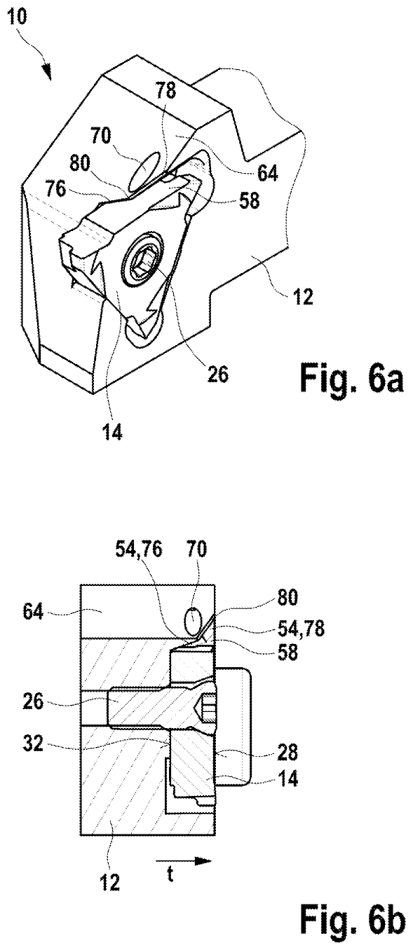

FIGS. 6a and 6b show a second exemplary embodiment of the tool 10. This exemplary embodiment differs from the first exemplary embodiment shown in FIG. 1-5 essentially in the way the gap 58 is configured.

In this case, the third wall 54, which forms the underside of the superstructure 64, has two partial surfaces 76, 78 oriented to one another that merge into one another along an edge 80. In other words, in this exemplary embodiment the third wall 54 has an angled design.

A configuration of this kind has the particular advantage that the gap 58 is opened even more widely towards the outside, without this adversely affecting the coolant outlet opening 70, however. Said coolant outlet opening can still remain in place.

The gap 58, which is even more open towards the outside, ensures further improved chip removal.

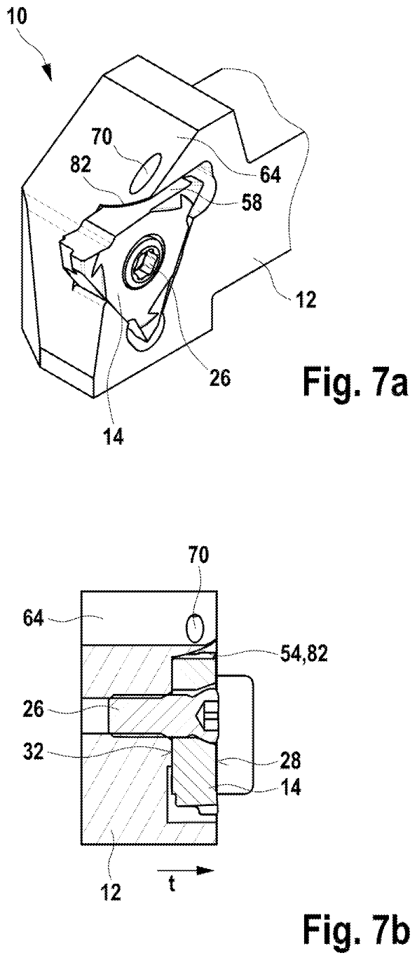

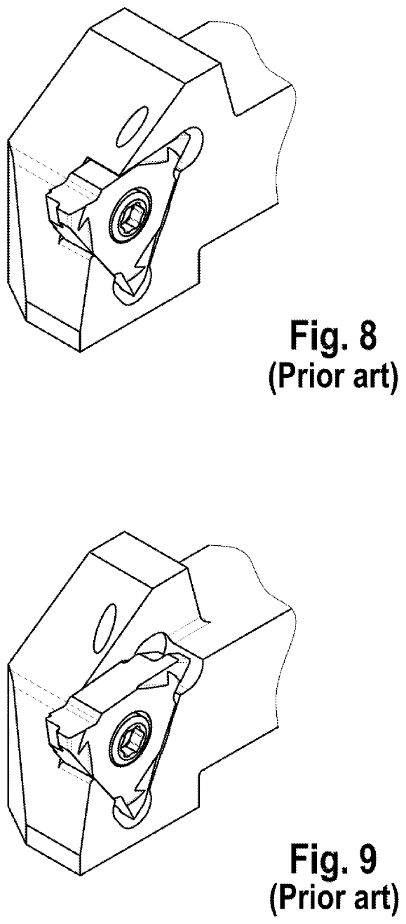

FIGS. 7a and 7b show a third exemplary embodiment of the tool 10. In this case, the third wall 54, which forms the underside of the superstructure 64, is configured as a curved surface 82. This curved surface 82, when viewed in cross-section, can be configured as a sector of a circle or part of an ellipsis. This curved surface 82, which preferably has a concavely curved design to avoid interfering with the coolant outlet opening 70, can also be configured as a free-form surface.

All three exemplary embodiments shown in this case have in common that the gap 58 increases continuously along the gap depth direction t from the inside to the outside, so starting from the rear side 32 of the cutting insert towards the front side 28 of the cutting insert.

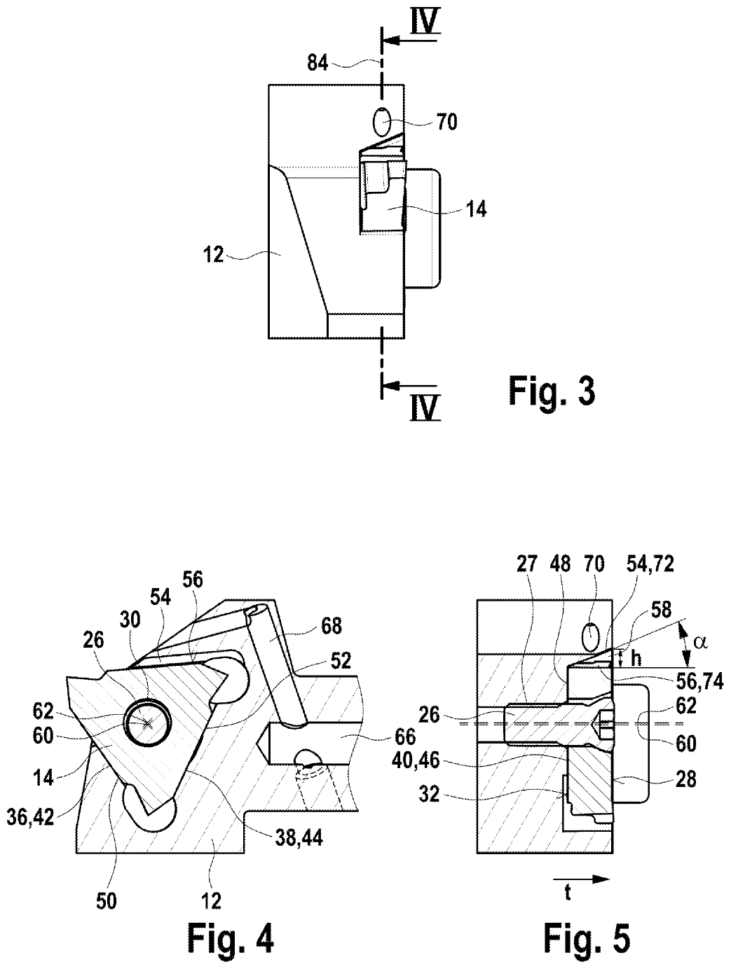

According to all the exemplary embodiments shown here, the coolant outlet opening 70 is arranged in such a manner that the coolant jet emerging therefrom strikes the active cutting edge 24 as centrally as possible. An imaginary plane 84 that divides the coolant outlet opening 70 into two equal halves intersects the upper side 56, the first cutting insert bearing section 36, and the second cutting insert bearing section 38, in the assembled state of the cutting insert 14. This imaginary plane 84 preferably intersects the planar surface 77 arranged on the upper side 56, the first cutting insert bearing section 36, and the second cutting insert bearing section 38 orthogonally. This imaginary plane 84 corresponds to the sectional plane IV-IV indicated in FIG. 3. The imaginary plane 84 is preferably oriented parallel to the first and the second side 28, 32 of the cutting insert 14 and is arranged therebetween.

Finally, it should once again be mentioned that, in principle, any of the other two cutting edges 24′,24″ can also be used as the active cutting head of the cutting insert 14. For example, in the event that the active cutting head 24 is worn, the cutting insert 14 is separated from the tool holder 12 by loosening the clamping screw 26, rotated through 60°, and then reattached to the tool holder 12. When rotated through 60° clockwise, the cutting head 24″ would then be used as the active cutting edge. It is understood that in this case, the first cutting insert bearing section 36 forms the upper side 56 or the planar surface 74 arranged thereon, and the second cutting insert bearing section 38 shown in the exemplary embodiments then acts as the first cutting insert bearing section 36.

Furthermore, it should be mentioned that various design changes can be made to the tool holder 12 and the cutting insert 14, without departing from the spirit and scope of the present disclosure, which particularly relates to the formation of the gap 58 and the outward opening thereof. Instead of a cutting insert 14 that is essentially triangular when viewed in a lateral plan view, as shown here, a four-sided, five-sided, six-sided, or polygonal cutting insert 14 can also be used. In these cases too, it is preferred to have the cutting insert abut along three surfaces oriented transversely to one another, one of which is oriented orthogonally to the longitudinal axis 62 of the opening 30, and the other two are oriented parallel to this opening longitudinal axis 62. The opening angle between the two cutting insert bearing sections 36, 38 would then correspond to the inner angle of the regular polygon in each case (e.g. 90° for a square cutting insert, 108° for a pentagonal cutting insert, and 120° for a hexagonal cutting insert).

What is claimed is:

1. A tool for machining a workpiece, comprising:
a cutting insert having a first side, a second side opposite the first side, and a circumferential surface extending between the first side and the second side, wherein the cutting insert comprises an opening penetrating through the first side and the second side and extending along a longitudinal axis, wherein a first cutting insert bearing section and a second cutting insert bearing section extending transversely to the first cutting insert bearing section are arranged on the circumferential surface, and a third cutting insert bearing section is arranged on the second side, wherein the cutting insert has an active cutting edge arranged on a upper side, said upper side being a part of the circumferential surface and facing away from the first cutting insert bearing section and the second cutting insert bearing section;
a tool holder having a cutting insert receptacle comprising a recess and being configured to receive the cutting insert in such a manner that a first part of the cutting insert is arranged in the recess, and a second part of the cutting insert, on which the active cutting edge is arranged, is located outside the cutting insert receptacle and protrudes at least partially from the tool holder, wherein the cutting insert receptacle is defined by a first wall, a second wall, a third wall extending transversely to the first wall and the second wall, and a recess base extending transversely to the first wall, the second wall, and the third wall, wherein a first holder bearing section is arranged on the first wall, which first holder bearing section, in an assembled state of the cutting insert, bears against the first cutting insert bearing section, wherein a second holder bearing section is arranged on the second wall, which second holder bearing section, in the assembled state of the cutting insert, bears against the second cutting insert bearing section, wherein a third holder bearing section is arranged at the recess base, which third holder bearing section, in the assembled state of the cutting insert, bears against the third cutting insert bearing section, and wherein the tool holder further comprises an internal coolant channel that opens into a coolant outlet opening which is oriented towards the upper side of the cutting insert in the assembled state of the cutting insert; and
a clamping element that is configured to be inserted, starting from the first side of the cutting insert, into the opening to fasten the cutting insert in a detachable manner to the tool holder;
wherein in the assembled state of the cutting insert the third wall of the cutting insert receptacle faces the upper side of the cutting insert and a gap is provided between the third wall of the cutting insert receptacle and the upper side of the cutting insert, wherein a height of the gap increases along a gap depth direction that is parallel to the longitudinal axis of the opening, starting from the second side of the cutting insert towards the first side of the cutting insert, wherein the height of the gap is defined as a distance of the upper side of the cutting insert from the third wall of the cutting insert receptacle.

2. The tool as claimed in claim 1, wherein the height of the gap increases continuously along the gap depth direction from the second side of the cutting insert to the first side of the cutting insert.

3. The tool as claimed in claim 1, wherein the third wall comprises a first planar surface, and wherein the upper side of the cutting insert comprises a second planar surface extending at an acute angle relative to the first planar surface in the assembled state of the cutting insert.

4. The tool as claimed in claim 3, wherein the acute angle is between 3° and 60°.

5. The tool as claimed in claim 3, wherein the acute angle is between 10° and 45.

6. The tool as claimed in claim 3, wherein the acute angle is between 15° and 30°.

7. The tool as claimed in claim 3, wherein the second planar surface extends parallel to the longitudinal axis of the opening.

8. The tool as claimed in claim 1, wherein the third wall comprises a first partial surface and a second partial surface extending transversely to the first partial surface, wherein the first partial surface merges into the second partial surface along an edge.

9. The tool as claimed in claim 1, wherein the third wall comprises a curved surface.

10. The tool as claimed in claim 1, wherein the first cutting insert bearing section and the second cutting insert bearing section are oriented at an angle of 60° to one another.

11. The tool as claimed in claim 1, wherein the coolant outlet opening is arranged on a front side component of the tool holder that is integrally formed with the third wall.

12. The tool as claimed in claim 1, wherein an imaginary plane that divides the coolant channel outlet opening into two equal halves, in the assembled state of the cutting insert, intersects the upper side, the first cutting insert bearing section, and the second cutting insert bearing section.

13. The tool as claimed in claim 1, wherein the third cutting insert bearing section extends orthogonally to the longitudinal axis of the opening.

14. The tool as claimed in claim 1, wherein the cutting insert is rotationally symmetrical to the longitudinal axis of the opening.

15. The tool as claimed in claim 1, wherein, in the assembled state of the cutting insert, the clamping element presses the first cutting insert bearing section against the first holder bearing section, the second cutting insert bearing section against the second holder bearing section, and the third cutting insert bearing section against the third holder bearing section.
